(19) United States
(12) Patent Application Publication
(10) Pub. No.: US 2006/0245866 A1
(43) Pub. Date: Nov. 2, 2006

(54) Method and apparatus for controlling motorized vehicle travel in a pick state

(76) Inventors: Timothy L. Rose, Winterville, NC (US); Matthew K. Hoffman, Greenville, NC (US)

Correspondence Address: MARGER JOHNSON & MCCOLLOM, P.C., 210 SW MORRISON STREET, SUITE 400, PORTLAND, OR, 97204, US

(21) Appl. No.: 11/110,095

(22) Filed: Apr. 19, 2005

(51) Int. Cl. B65F 9/00

(52) U.S. Cl. 414/392

(57) ABSTRACT

A system for controlling a motorized vehicle, comprising: a controller configured to activate a pick state for a motorized vehicle only while the motorized vehicle is in a low speed travel made and a control arm is located in a non-braking position, the controller further configured to override a dead-man brake mechanism and automatically actuate a traction motor that drives the motorized vehicle within the low speed travel mode while the pick state is activated.

### BACKGROUND

An industrial pallet truck is utilized to lift and transport loads between locations. The operator of the pallet truck may be required to move loads repeatedly on and off of the pallet truck within a very short period of time, and is often required to move specific inventory from various locations in what is termed “picking.” During this practice, it is desirable that the operator can leave the pallet truck and pick a load while the pallet truck continues to move in the direction of the next load. In this way, the lifting and transporting of loads is most efficient. To avoid inadvertent vehicle travel, pallet trucks have a dead-man mechanism that engage a vehicle brake in the event that the operator leaves the pallet truck and releases the control arm. It is not possible for the operator to continue to hold the control arm in a non-braking position as he leaves the pallet truck and moves to the next pick location, therefore it is desirable to have a coast control system which retards, or overrides the dead-man brake mechanism, to allow the pallet truck to coast. The coast control system typically holds the control arm in a fixed or variable position between vertical and horizontal, such that the vehicle brake does not become engaged, and the pallet truck is allowed to coast to a stop in a controlled manner. Coast control systems are well known in the art, for example whereby a control arm brake is used to prevent the control arm from moving back to a vertical braking position.

Coast control systems known require an actuation mechanism on the pallet truck that places the pallet truck in a low speed travel mode, and activates the coast control device that overrides the dead-man brake. After the coast control system is activated, the operator is able to actuate the traction motor by means of a pick button or throttle, for example, which powers the pallet truck in a low travel speed mode. Such systems are inefficient, in that they require activation of multiple controls in order to actuate the traction motor within the low speed travel mode, or require multiple activations of the same control to accomplish this task. Some existing coast control systems provide for a coast control button on the control arm handle that must be pressed to activate the coast control system, and a separate pick button, or “jog switch”, that must be pressed to actuate the traction motor after the coast control system has been activated. Another related system provides for a coast control button on the control arm control head that first functions as means of selecting the low speed travel mode and activating the coast control system, and then must be pressed subsequently to actuate the traction motor. While both of these systems control the mode of travel and operation of the coast control system, they are not efficient or intuitive. The present invention addresses these and other problems associated with the prior art.

### SUMMARY OF THE INVENTION

The present invention provides for an improved method and system to control the operability of a motorized vehicle such as an industrial pallet truck. The improved method relates to the simplified and intuitively functional and logical operation of the motorize vehicle in the pick state, or walking state.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a perspective view of a typical pallet truck in which the present invention may be made operable;

FIG. 2 is a perspective view of the steer control handle;

FIG. 3 is a perspective view of the control panel located on the support bar;

FIG. 4 is a perspective view of the coast control system and control arm locking mechanism;

FIG. 5 is a side view of the control arm, depicting three different ranges of motion;

FIG. 6 is a schematic diagram depicting the functionality of the coast control system and pick state;

FIG. 7 is a flow diagram showing the logical flow of the pick state of the motorized vehicle; and

FIG. 8 is a perspective view of an alternate embodiment of the invention, with a coast control button located on the operator platform.

### DETAILED DESCRIPTION

A detailed description of the invention will now be provided, making reference to the accompanying figures.

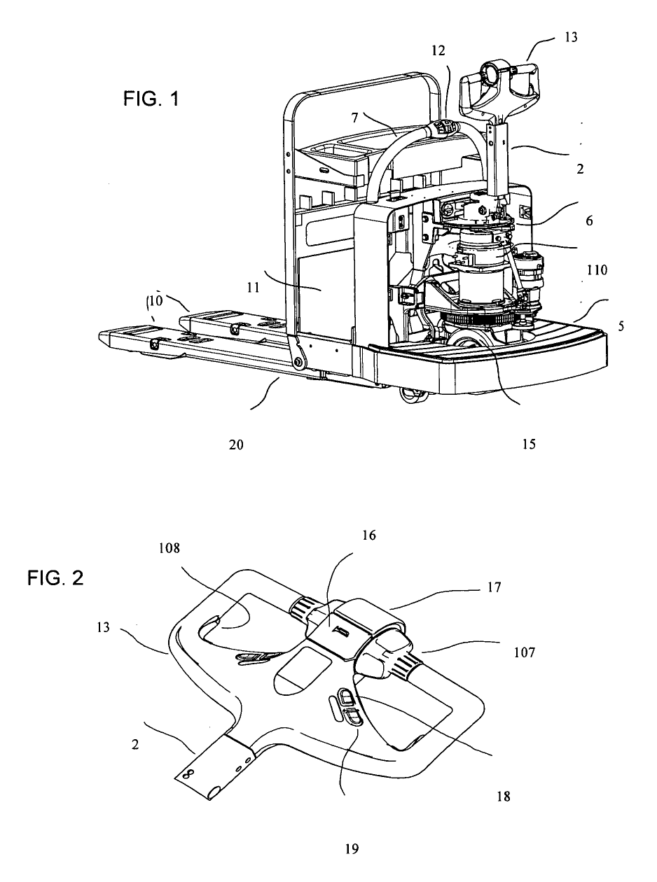

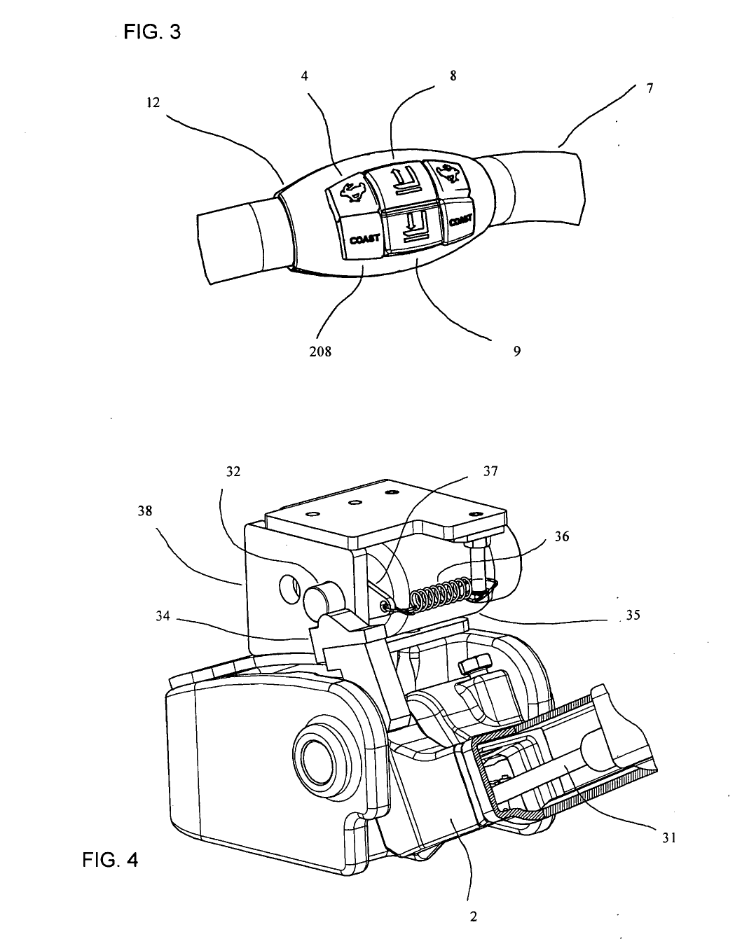

FIG. 1 shows a typical pallet truck 20 which may be used with the present invention. The pallet truck 20 includes an operator platform 5, by which the operator (not shown) may stand on the pallet truck 20 during high speed travel. From the operator platform 5, the operator is able to reach the support bar 7 and steer control handle 13. The support bar 7 has at its center point a control panel 12, which is shown in more detail in FIG. 3. The pallet truck 20 is powered by a traction motor 1 10 which is energized by a battery 111 (FIG. 6) located in the battery compartment 1 1. The steer control handle 13, which is shown in greater detail in FIG. 2 includes a horn button 16, an emergency reverse button 17, a lift button 18, and a lower button 19. The lift button 18 and lower button 19 lift and lower, respectively, the forks 11 upon which a load is placed. The emergency reverse button 17 reverses the direction of the traction motor 110. The steer control handle 13 is attached by means of a steer control arm 2 to a steer control unit 6 which controls the direction of a drive wheel 15, which is located directly under the traction motor 1 10, and controls the direction of travel of the pallet truck 20.

The present invention provides for a pick button 108 that activates a pick state, and thereby activates both a coast control system 109 and a traction motor 110 at the first instance of it being pressed. The pick button 108 may then be repressed as necessary to again actuate the traction motor 110 within a low speed travel mode, with the coast control system 109 continuing to be activated throughout. The advantage of this invention is in the immediate responsiveness of the pallet truck 20 to the operator's desire to both engage the coast control system 109 and actuate the traction motor 110 in order to most efficiently initiate the picking process. The present invention describes a system whereby the pallet truck 20 operates in the low speed travel mode unless the operator takes definite action to activate a high speed travel mode, or a vehicle brake switch 101 (FIG. 6) is activated. Because the pick button 108 is disabled in the high speed travel mode, the pallet truck 20 may only be operated in the pick state while the pallet truck 20 is in the low speed travel mode.

The steer control handle 13 has two symmetrically located pick buttons 108 and two symmetrically located variable throttles 107. When the operator is on the operator platform 5 or is walking alongside of the pallet truck 20, the operator may activate the pick button 108 or throttle 107 with the same hand that is holding and controlling the steer control handle 13. The pallet truck 20 is accelerated by means of a traction motor 110 that may be operated in either the low speed travel mode or the high speed travel mode. In either low speed or high speed travel modes, the traction motor 110 may be actuated by means of the throttle 107. The rate of acceleration and maximum travel speeds obtained in the low and high speed travel modes are determined according to the current limiting characteristics of the low and high speed travel circuits, respectively. For example, the low speed travel mode provides for a maximum travel speed of approximately 3.5 miles per hour. Activation of the throttle 107 will cause the traction motor 110 to move in the forward or reverse direction in the low speed travel mode depending on the command sent by the throttle 107 to the traction motor 1 10. In the example pallet truck 20 shown in FIG. 1 and FIG. 2, the throttle 107 is a butterfly type design which may be rotated forward, away from the operator, to cause the pallet truck 20 to move in the reverse direction, or may be rotated backward, towards the operator, to cause the pallet truck 20 to move in the forward direction, similar to a conventional motorcycle throttle. Other types of throttle 107 may be used, such as twist grips, buttons, toggles, and pedals, without affecting the function of the present invention. Similarly, different positions or more instances of the pick button 108 do not affect the function of the present invention.

With the throttle 107 positioned in the forward or reverse direction, the operator may simultaneously or sequentially press either of the two symmetrically located high speed buttons 4, located on the control panel 12 (FIG. 3). The operator may then continue to activate the throttle 107 in the high speed mode, whereby the pallet truck 20 is able to travel at a higher maximum speed, for example when the operator needs to move a greater distance between picking loads. If the throttle 107 is released or placed in a neutral position, the pallet truck 20 will coast to a stop, or be caused to brake depending on the position of the steer control arm 2. Subsequent activation of the throttle 107 will cause the pallet truck 20 to travel in the low speed mode until and unless the high speed button 4 is again activated.

The control panel 12 is further equipped with two symmetrically located auxiliary pick buttons 208, an auxiliary lift button 8 and an auxiliary lower button 9, which function to lift and lower, respectively, the forks 10. Auxiliary pick button 208, auxiliary lift button 8, and auxiliary lower button 9, function the same as pick button 108, lift button 18, and lower button 19, respectively. Where this written description references any of the buttons located on the steer control handle 13, the associated auxiliary button on the control panel 12 will be assumed to provide the same functionality and achieve the same result as if it had instead been pressed by the operator. An alternate embodiment of the invention provides for the auxiliary pick buttons 208 functioning purely to activate the coast control system 109, and not actuate the traction motor 110 on the initial or any subsequent activation of the auxiliary pick buttons 208. In this embodiment, actuation of the traction motor 110 would be accomplished by activating the pick buttons 108 after the coast control system 109 has first been activated.

With the pallet truck 20 in a powered-down state, a pneumatic control arm return spring 31 (FIG. 4) causes the control arm 2 to remain in a vertical position, thereby activating a vehicle brake switch 101. The return spring 31 retains the control arm 2 in the vertical position in the powered-down and powered-up states unless moved to a non-vertical position by the operator. While the control arm 2 of the pallet truck 20 is in a braking position, the low and high speed travel circuits may not be energized, and therefore the traction motor 110 may not be actuated, even after the key switch 100 has been turned on and the pallet truck 20 has been powered-on.

With the pallet truck 20 in a powered-on state, and the control arm 2 lowered to a non-braking position, the pallet truck 20 automatically enters the low speed travel mode. In this mode, the operator may operate the pallet truck 20 when riding on, when walking alongside, or walking behind, the pallet truck 20. If the operator releases the control arm 2, the return spring 31 will cause the control arm 2 to return to a vertical position and activate the vehicle brake switch 101 thereby causing the pallet truck 20 to stop. The coast control system 109 is activated anytime the pallet truck 20 is in the pick state.

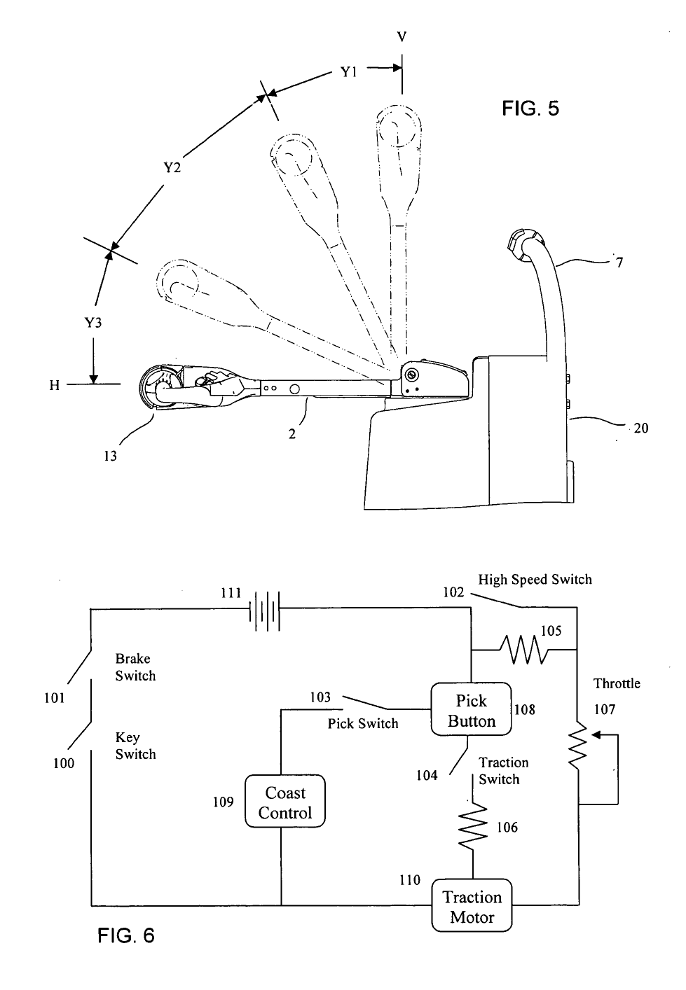

The dead man brake mechanism and coast control system 109 is shown in FIG. 4 and is comprised of a pneumatic control arm return spring 31, a control arm detent 32, a rubber control arm stop 34, an electric push solenoid 35, a solenoid return spring 36, a detent return plate 37, and a solenoid holding weldment 38. The dead-man brake mechanism functions when the operator ceases to hold the control arm 2 in a non vertical position. In this case, the return spring 31 will normally apply a force to move the control arm 2 to a vertical, braking position, which in turn activates the vehicle brake switch 101. However, the return spring 31 force may be overcome by the operator holding the steer control handle 13 in a lowered position. Activation of the pick button 108 will cause the solenoid 35 to eject the detent 32 through a hole in the solenoid holding weldment 38 and into the path of the control arm stop 34. The friction between the control arm stop 34 and the detent 32 is enough to overcome the force applied by the control arm return spring 31, and instead maintain the control arm 2 in a non-vertical position. When the coast control system 109 is activated, the control arm 2 is locked in the position intermediate between pivot ranges Y1 and Y2 (FIG. 5). As a result, the control arm 2 will remain in a non-braking position even if the operator releases both the pick button 108 and the steering handle 13, and the pallet truck 20 will be allowed to coast to a stop if no further operator intervention occurs. The operator can overcome the friction force between the control arm stop 34 and the detent 32 by applying pressure to the steer control handle 13 in either an upward or downward motion, and move the control arm 2 to a braking position, thereby activating the vehicle brake switch 101 in order to apply a braking force to the pallet truck 20. A force of approximately 15 pounds applied at the steer control handle 13 will cause the rubber control arm stop 34 to deform sufficiently for it to pass by the detent 32, and thereby disengage the coast control system 109.

The coast control system 109 described in this invention provides for retaining the control arm 2 in a fixed position between vertical and horizontal, however other locking mechanisms can be employed, such as a magnetic or friction device, which would hold the control arm 2 in any one of an infinite number of positions between vertical and horizontal.

When the control arm 2 is forced out of the fixed position held by the coast control system 109, the solenoid 35 will cease to apply force to the detent 32, and instead the solenoid return spring 36 will cause the detent 32 to retract through the solenoid holding weldment 38 and away from the control arm stop 34 by means of the movable detent return plate 37 which is attached directly to the detent 32.

With the pallet truck 20 operating in the low speed travel mode, the operator is able to activate the pick state, or walking state, of the pallet truck 20 by activating a pick button 108. The pick button 108, or other type of switch, may be located anywhere on the truck, including the control arm handle 13, the operator platform 5, or on the support bar 7, for example. In the preferred embodiment, the pick state is activated by means of a pick button 108 located on the control arm handle 13. In the pick state, the coast control system 109 of the pallet truck is activated which causes the control arm 2 to remain in a non-braking position, and thereby prevents the vehicle brake switch 101 from being activated. As a result, the pallet truck 20 is allowed to coast to a stop after the traction motor 110 is de-actuated.

Activation of the pick button 108 will cause the pallet truck 20 to move in the forward direction, towards the forks 10, up to the maximum allowable travel speed in the low speed travel mode, and will also override the return spring 31. The pallet truck 20 will continue being accelerated in the forward direction so long as the pick button 108 is being depressed. When the operator releases the pick button 108, the pallet truck 20 coasts to a stop regardless of whether or not the operator maintains physical contact with the pallet truck 20 or control arm 2, thereby allowing the operator to walk alongside, or ahead of the pallet truck 20 to pick the next load. While the pallet truck 20 is in the pick state, the operator is able to repeatedly accelerate the pallet truck 20 within the low speed travel range by either reactivating the pick button 108, or by holding open the throttle 107. The pallet truck 20 will remain in the pick state until the vehicle brake switch 101 is activated, the high speed travel button 4 is activated, the battery 111 is disconnected, or the key switch 100 is turned off. The battery 111 may become disconnected from the electrical circuit by physical removal of connecting wiring or if the operator presses an emergency off button (not shown), and in either case the pallet truck 20 will no longer be operating in the pick state. If the operator manually forces the control arm 2 into either a vertical or horizontal position, the vehicle brake switch 101 will be activated, the traction motor 108 will be de-actuated as the low and high speed travel circuits are open, and the pallet truck 20 will no longer be operating in the pick state.

Activation of the throttle 107, pick button 108, and the high speed button 4 is only possible with the control arm 2 in the non-braking position. The braking positions of the control arm 2 is specified by an approximate vertical position V and approximate horizontal position H as shown in FIG. 5. The term approximate as used in the preceding sentence, could be understood to provide a tolerance of 3 to 5 degrees from the vertical or horizontal position, for example. The throttle 107, pick button 108, and the high speed button 4 may all be normally applied when the control arm is located in range Y2. As the control arm 2 approaches the vertical and horizontal braking positions, and is in the ranges of motion shown as Y1 and Y3, the level of performance of the traction motor 110 is maintained at a lower value so as to avoid abrupt changes in acceleration of the pallet truck 20. These systems recognize that when the control arm 2 is in a near vertical position that the operator is likely preparing to brake the pallet truck 20, and requires more sensitive control for steering and acceleration at these lower speeds. By causing a reduction in the overall rate of acceleration of the pallet truck 20, the operator is able to control the speed of the pallet truck 20 in finer increments while using the same throttle 107 as at normal travel speeds. Similarly, the preferred embodiment of this invention teaches that the high speed button 4 would only be functional in the range Y2, or instead would provide for an intermediate vehicle acceleration rate less than the maximum high speed travel rate and greater than the low speed travel rate.

FIG. 6 provides an illustrative circuit for the preferred embodiment of the invention. This circuit provides for various modes of travel, including low speed travel mode, high speed travel mode, coast control, and the pick state or walking state. With the pallet truck 20 in a powered-down state, all switches shown in FIG. 6, including 100, 101, 102, 103 and 104, are open, and the return spring 31 causes the control arm 2 to spring to a vertical position and activate the vehicle brake switch 101. When the pallet truck 20 is powered on, key switch 100 is closed, however the circuit is still not energized because the brake switch 101 remains open. When the vehicle brake switch 101 is activated it remains open. To close the brake switch 101, the operator is required to move the control arm 2 into a position between vertical and horizontal. Once both switches 100 and 101 are closed, the circuit is energized in a low speed travel mode. In the low speed travel mode, acceleration of the pallet truck 20 via a traction motor 110 may be accomplished by use of the variable throttle 107 which provides a limited predetermined rate of travel for the pallet truck 20 according to the current restriction provided by the low speed travel mode resistor 105.

With the control arm 2 located in a non-braking position, the operator can activate the pick state by pressing the pick button 108. Pressing the pick button 108 will close the pick switch 103, thereby activating the coast control system 109, and will also close the traction switch 104 and actuate the traction motor 110 in the low speed travel mode as limited to a predetermined rate of travel for the pallet truck 10 according to the current restriction provided by the pick state resistor 106. Pick state resistor 106 provides for the same current restriction as discussed for the low speed travel mode resistor 105. Pick switch 103 will remain closed even after the pick button 108 is released, and will remain closed in the pick state until one of the following conditions occurs: the vehicle brake switch 101 is activated, the high speed switch 102 is activated, the battery 111 is disconnected, or the key switch 100 is turned off. Traction switch 104 will remain closed only so long as the pick button 108 is pressed. Therefore, the traction motor 110 will be de-actuated when the pick button 108 is released.

With the pick switch 103 closed, and the coast control system 109 activated, the control arm 2 is held in a fixed position between vertical and horizontal by the coast control system 109 which thereby overrides the return spring 31. The coast control system 109 is further described in FIG. 4. Therefore, when the operator releases the pick button 108, the traction motor 110 is de-actuated, however the coast control system 109 continues to override the return spring 31 thus allowing the pallet truck 20 to coast to a stop even when the operator is no longer holding the control arm 2 in a non-braking position. This allows the operator to leave the moving pallet truck 20, and walk alongside or ahead of the pallet truck 20 in order to pick the next load. This is considered the pick state or walking state of the pallet truck 20 operation. Pick state allows for continuous activation of the coast control system 109 and actuation of the traction motor 110 in the low speed travel mode, either by pressing the pick button 108 or engaging the throttle 107.

The operator may activate the high speed travel mode by simultaneously or sequentially engaging the throttle 107 and pressing the high speed button 4, which closes the high speed switch 102. After the throttle 107 is engaged, the high speed switch 102, will remain closed until the throttle 107 is placed in neutral, the battery 111 is disconnected, or the key switch 100 is turned off. When the high speed switch 102 is closed, the pick button 108 is disabled, and both the pick switch 103 and the traction switch 104 become open. This results in the de-activation of the coast control system 109 if the pallet truck 20 was in the pick state prior to activation of the high speed travel mode.

Disconnecting the battery 1 11, opening the key switch 100, or opening the brake switch 101, will cause all other switches in the circuit to become open, preventing engagement of the traction motor 110 in any of the travel modes or operating states discussed.

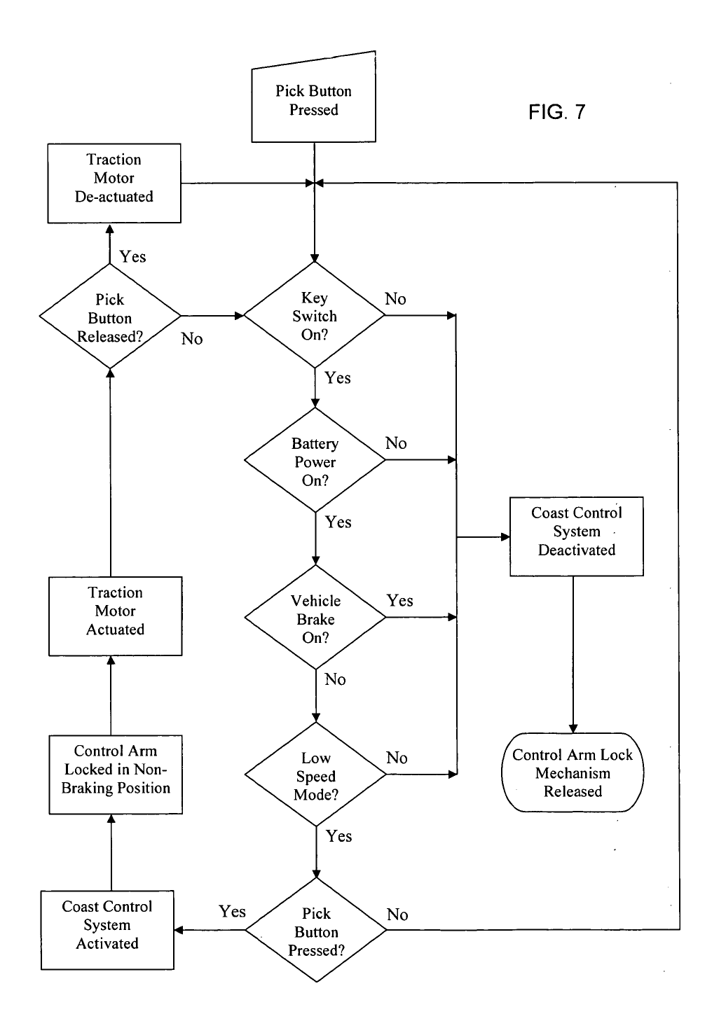

FIG. 7 shows an example flow diagram of the pick state logic of the pallet truck 20, as monitored by an on-board processor (not shown). When the operator presses the pick button 108, the pallet truck's on-board processor evaluates the state of the electrical and mechanical operating systems. Pressing the pick button 108 will have no effect if any of the following prior conditions exist: key switch 100 is turned off, battery power is disconnected, the control arm 2 is in a braking position, or the pallet truck 20 is in a high speed travel mode. If none of these conditions exist, then the coast control system 109 is activated which causes the control arm 2 to become locked in a non-braking position, and the traction motor 110 is engaged while the pick button 108 is pressed. If the pick button 108 is released, the traction motor 110 de-actuates, and the on-board processor will go into a system check loop until the pick button 108 is again pressed, or any of the aforementioned conditions occur. If any of the aforementioned conditions occur, the coast control system 109 will deactivate and the locking mechanism 32 will be released. The control arm 2 will then move to a substantially vertical position, unless the operator applies force to retain the control arm 2 in a non-braking position, which will cause the vehicle brake switch 101 to remain closed.

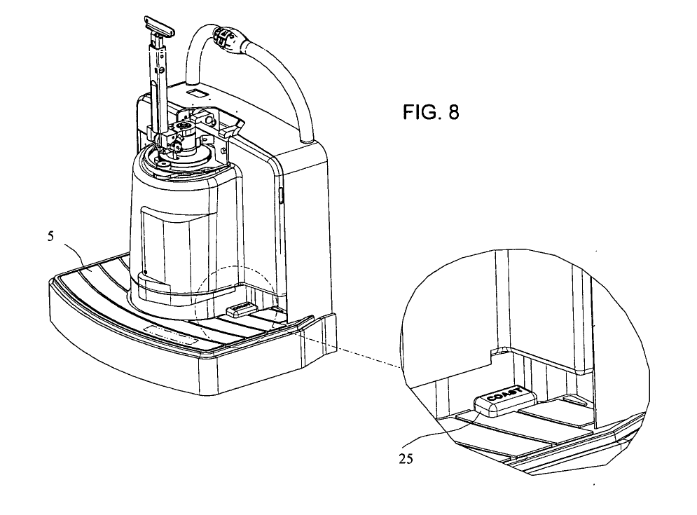

An alternative embodiment of this invention provides for a coast control enable button 25 (FIG. 8) mounted to the operator platform 5 whereby the operator first enables the coast control system by depressing the coast control enable button 25, and is then able to accelerate the pallet truck 20 in the pick state by means of the throttle 107 or pick button 108. The coast control enable button 25 could serve to activate the coast control system 109 but not actuate the traction motor when it is initially pressed. Pressing the coast control enable button 25 a second time could be set to either actuate the traction motor 110, or deactivate the coast control system 109. Coast control enable button 25 can be made to simultaneously actuate the traction motor 110, and provide for subsequent actuation of the traction motor after the coast control system 109 has been activated. In this case, coast control enable button 25 would operate the same in all respects as the pick button 108, other than its location, and as described in this patent. If the coast control enable button 25 does not actuate the traction motor 110 then pressing the coast control enable button 25 could alternate between activating and deactivating the coast control system. If the coast control enable button 25 actuates the traction motor 110, then the traction motor 110 could be actuated upon the first instance of the coast control enable button 25 being pressed, and each successive time the coast control enable button 25 is pressed.

Other components, methods, and systems of the pallet truck 20 that are not described in this patent are understood to operate in a similar manner to other conventional pallet trucks known in the existing art. The system and apparatus described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or diagrams. This is not necessary, however, and there may be cases where these functional blocks or diagrams are equivalently aggregated into a single logic device, program or operation with unclear boundaries.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A method for controlling the speed of a motorized vehicle, comprising:
activating a pick state while the vehicle is in a low speed travel mode and a control arm is located in a non-braking position, the pick state overriding a dead-man brake mechanism; and
automatically actuating a traction motor that drives the vehicle within the low speed travel mode.

2. The method according to claim 1 including activating a pick button or switch on the motorized vehicle to activate the pick state.

3. The method according to claim 2 including de-actuating the traction motor and allowing the motorized vehicle to coast to a stop when the pick button or switch is de-activated.

4. The method according to claim 3 including accelerating the vehicle in the low speed travel mode while the pick button or switch is being activated or when the pick button or switch is reactivated.

5. The method according to claim 2 including accelerating the vehicle in the low speed travel mode while a throttle is held open, and continuously overriding the dead-man brake mechanism when the throttle is released.

6. The method according to claim 1 including preventing activation of the pick state when the truck is in a high speed travel mode or when the control arm is in a braking position.

7. The method according to claim 1 including activating the pick state with the control arm held at a fixed position between vertical and horizontal.

8. The method according to claim 7 including de-activating the pick state by manually forcing the control arm out of the fixed position.

9. The method according to claim 8 including de-activating the pick state and applying the truck brakes when the control arm is in a substantially vertical or horizontal position.

10. The method according to claim 1 including de-activating the pick state and engaging the dead-man brake mechanism whenever:
a brake is applied, a high speed travel button or switch is activated, a battery is disconnected, or a key switch is turned off.

11. The method according to claim 1 including disabling the pick state while the motorized vehicle is in a high speed travel mode.

12. The method according to claim 11 including enabling the high speed travel mode by sequentially or simultaneously applying a throttle and activating a high speed travel actuation device while the control arm is in a non-braking position.

13. The method according to claim 12 whereby the high speed travel actuation device is a button or switch located on a support bar of the motorized vehicle.

14. The method according to claim 12 whereby the high speed travel actuation device operates as the throttle and activates the high speed travel mode.

15. The method according to claim 11 including disabling the high speed travel mode and enabling the low speed mode whenever a brake is applied, a throttle is placed in neutral, a battery is disconnected, or a key switch is turned off.

16. A system for controlling a motorized vehicle, comprising:
a controller configured to activate a walking state for a motorized vehicle only while the motorized vehicle is in a low speed travel mode and a control arm is located in a non-braking position;
the controller further configured to override a dead-man brake mechanism and automatically actuate a traction motor that drives the motorized vehicle within the low speed travel mode while the walking state is activated.

17. The system according to claim 16 including an actuation device that signals the controller to override the dead-man brake mechanism.

18. The system according to claim 17 whereby the dead-man brake mechanism remains disabled when the actuation device is activated or reactivated.

19. The system according to claim 17 whereby the motorized vehicle is accelerated in the low speed travel mode while the actuation device is activated or when the actuation device is reactivated.

20. The system according to claim 16 whereby the walking state is disabled and the dead-man brake mechanism is engaged whenever:
a brake is applied, a high speed travel button or switch is activated, a battery is disconnected, or a key switch is turned off.

21. The system according to claim 16 including a throttle which actuates the traction motor in the low speed travel mode and a high speed travel mode.

22. The system according to claim 21 whereby the high speed travel mode is enabled by sequentially or simultaneously applying the throttle and a high speed travel button or switch, with the control arm in a non-braking position.

23. A method for controlling the speed of a pallet truck, comprising:
activating an actuation device on the pallet truck to activate a materials handling state whereby the pallet truck travels at a walking speed to enable loading and unloading of materials from the pallet truck, the materials handling state overrides a dead-man brake mechanism and is activated only while the pallet truck is in a low speed travel mode and a control arm is located in a non-braking position; and
automatically actuating a traction motor that drives the vehicle within the low speed travel mode.

24. The method according to claim 23 including actuating the traction motor in the low speed travel mode as long as the actuation device is being activated or when the actuation device is reactivated.

25. The method according to claim 24 including de-actuating the traction motor and allowing the pallet truck to coast to a stop when the actuation device is de-activated.

26. The method according to claim 25 including preventing activation of the materials handling state when the pallet truck is in a high speed travel mode or when the control arm is in a braking position.

27. The method according to claim 26 including de-activating the materials handling state and engaging the dead-man brake mechanism whenever:
a brake is applied, a high speed actuation device is activated, a battery is disconnected, or a key switch is turned off.

28. A method for controlling the speed of a pallet truck, comprising:
activating an actuation device located on the operator platform of the pallet truck to activate a pick state whereby the pallet truck travels at a walking speed to enable loading and unloading of materials from the pallet truck, the pick state overrides a dead-man brake mechanism and is activated only while the pallet truck is in a low speed travel mode and a control arm is located in a non-braking position.

29. The method according to claim 28 including actuating the traction motor in the low speed travel mode as long as a pick button or switch is being activated or when the pick button or switch is reactivated, and the pick state is activated.

30. The method according to claim 28 including actuating the traction motor in the low speed travel mode as long as the actuation device is being activated or when the actuation device is reactivated.

31. The method according to claim 29 including alternating between activating and de-activating the pick state when the actuation device is activated and subsequently reactivated one or more times.

32. The method according to claim 28 including de-activating the pick state and engaging the dead-man brake mechanism whenever:
a brake is applied, a high speed actuation device is activated, a battery is disconnected, or a key switch is turned off.
